(19) United States
(12) Patent Application Publication
(10) Pub. No.: US 2006/0283317 A1
(43) Pub. Date: Dec. 21, 2006

(54) Missile protection system for vehicles

(75) Inventors: Stephan Melnychuk, Carlsbad, CA (US); Howard Hyman, San Diego, CA (US); David Sandler, San Diego, CA (US); R. Kyle Webb, Escondido, CA (US)

Correspondence Address: JOHN R. ROSS;TREX ENTERPRISES CORP., 10455 PACIFIC CENTER CT., SAN DIEGO, CA, 92121, US

(73) Assignee: TREX ENTERPRISES CORP

(21) Appl. No.: 11/184,509

(22) Filed: Jul. 18, 2005

Related U.S. Application Data
(60) Provisional application No. 60/588,911, filed on Jul. 16, 2004.
(60) Provisional application No. 60/643,902, filed on Jan. 13, 2005.

(51) Int. Cl. B64D 1/04; F41G 3/08; F41G 3/12

(52) U.S. Cl. 89/41.03; 89/1.11

(57) ABSTRACT

A projectile tracking system for acquiring and precisely tracking a projectile in flight in order to reveal the source from which the projectile was fired. The source is revealed by the back projection of a 3-dimensional track file. In preferred embodiments the system is installed on a vehicle, such as an un-manned blimp or other aircraft, road vehicle or ship, for locating and destroying small arms fire directed at the vehicle. A kill system may also be included on the vehicle to destroy the source of the projectile.

This invention relates to systems providing protection against small arms fire such as rifles and rocket powered grenades and especially to such systems providing such protection for aircraft, road vehicles and ships. This application claims the benefit of Provisional Applications Ser. Nos. 60/588,911 filed Jul. 16, 2004 and 60/643,902 filed Jan. 13, 2005.

### BACKGROUND OF THE INVENTION

During the past few years terrorist threats have increased dramatically and tremendous efforts have been made to counter these threats. Sniper, small arms and Rocket Propelled Grenade (RPG) attacks have emerged as tactics of choice for guerrilla and terrorist groups engaging U.S., allied, and United Nations forces in Iraq and Afghanistan. Small arms and low cost RPGs are a continuing threat to US personnel and aviation assets and both must be detectable by a common sensor. During the mid-1990's employees of Applicant's assignee, developed a projectile tracking system capable of detecting and tracking missiles, including missiles from small arms fire such as bullets and RPG's. These systems were described and patented in U.S. Pat. Nos. 5,796,474 and 6,057,951 which are incorporated herein by reference.

Fast infrared cameras are presently available which can take images of a rifle bullet during its trajectory. These devices form two-dimensional images and multiple sensors widely spaced are required to generate a 3-D track. Laser radar devices have been known for several years and are regularly used for determining the range-and speed of moving objects such as motor vehicles.

A need exists for a systems providing protection against small arms fire such as rifles and rocket powered grenades and especially to such systems providing such protection for aircraft.

### SUMMARY OF THE INVENTION

The present invention provides a projectile tracking system for acquiring and precisely tracking a projectile in flight in order to reveal the source from which the projectile was fired. The source. is revealed by the back projection of a 3-dimensional track file. In preferred embodiments the system is installed on a vehicle, such as an un-manned blimp or other aircraft, road vehicle or ship, for locating and destroying small arms fire directed at the vehicle. A kill system may also be included on the vehicle to destroy the source of the projectile.

Projectiles of interest are typically traveling at a substantial fraction of the speed of sound or even faster than the speed of sound, and therefore become hot due to aerodynamic heating. A telescope focuses infrared light from a relatively large field of view on to an infrared focal plane array. In a projectile detection mode, the system searches for the infrared signature of the fast moving projectile. The telescope's field of view is steered in the azimuth by a step and stare mirror which is driven by an azimuth drive motor mounted on a frame. When a projectile is detected the system switches to a tracking mode and the mirror is steered by the azimuth drive motor and a pivot motor to track the projectile. A short pulse high repetition rate laser in a laser radar system provides a pulsed laser beam which is optically co-aligned with the telescope axis. Mirror angular position information, laser radar pulse travel time and the missile spot position on the detector array are used by a computer to calculate bullet trajectory information and to determine the source or origin of the projectile using known ballistic trajectory methods. Although only a small portion of the total trajectory may be captured, the very accurate position information permits extrapolation to determine the launch point of the projectile.

A preferred sensor system designed to detect small arms fire and to control defensive counter-fire responses from helicopters or other airborne platforms has a combination of the following features: (a) wide angle surveillance coverage, (b) high effective probability of detection, even at low signal to noise ratios, (c) low false alarm rates to avoid depletion of the defensive gun's ammunition, (d) range accuracy of one or two meters, (e) angular accuracies of a few hundred micro-radians, (f) ability to communicate threat information in real-time via standard digital computer interfaces and (g) be very difficult to countermeasure. The sensor should be capable of being netted to other nearby combat airborne assets with a real time communication link to provide wide angles of defensive counter-fire to threat shooting positions. These stressing detection and tracking requirements can be realized by using a mid-wave infrared camera coupled to a very fast step-stare system with good pointing accuracy and have some capability for background subtraction (for clutter rejection). A laser rangefinder in the tracker is also required to provide the shooter ground position including range and the in flight munitions (such as bullets and rocket propelled grenades) range metric to minimize false alarms caused by flash-bang countermeasures or explosions.

### BRIEF DESCRIPTION OF THE DRAWINGS

FIG. 1 is a drawing of a preferred embodiment of the Projectile Tracking System of the present invention;

FIG. 2 is a drawing of a view of a position of the Projectile Tracking System shown in FIG. 1;

FIG. 3 is a drawing of an alternative embodiment of the Projectile Tracking System of the present invention;

FIG. 4 is a drawing of a portion of the Projectile Tracking System shown in FIG. 3;

FIG. 5 is a chart demonstrating a preferred step and stare process;

FIG. 6 is a perspective view of an alternative embodiment of the Projectile Tracking System of the present invention showing a stare mirror mounted axially above the azimuth drive motor, with the elevation of the stare mirror controlled by an elevation drive motor rotating an elevation cam;

FIG. 7 is a perspective view of the alternative embodiment of the Projectile Tracking System of the present invention shown in FIG. 6, detailing the elevation cam and the cam follower extending from the stare mirror;

FIG. 8 is another perspective view of the alternative embodiment of the Projectile Tracking System of the present invention shown in FIGS. 6 and 7, and details the shape of the elevation cam;

FIG. 9 is a cross-sectional view of the elevation cam taken along lines 9-9 of FIG. 7, showing the varying diameter of the elevation cam which, when rotated with respect to the azimuth drive motor, provides the elevation control of the stare mirror;

FIG. 10 is a graphical representation of the relationship between the elevation angle of the stare mirror and the rotational phase difference between the azimuth angle drive motor and the elevation angle drive motor; and

FIG. 11 is a side view of an alternative embodiment of the Projectile Tracking System.

FIGS. 12 and 13 are drawings of multiple target tracking systems.

FIGS. 14 and 15 show features of a tracking system called RTATS.

### DETAILED DESCRIPTION OF PREFERRED EMBODIMENTS

### First Preferred Embodiment

A first preferred embodiment is a third generation prototype Rapid Target Acquisition and Tracking System (called “RTATS”), which is designed to be vehicle mounted such as a (High Mobility Multi-Wheeled Vehicle) HMMWV to support defensive tactical weapons. Its design allows it to be used in helicopter carry experiments to detect rocket flights from the air. It is to conduct ground surveillance for threats such as rockets, mortars, artillery, RPG's and guided tactical missiles. The system provides surveillance and precision 3-D tracking sensor for active countermeasure weapon systems. This embodiment, as currently configured, serves as a helicopter baseline sensor suite to address and evaluate the bullet and RPG detection and tracking requirements for precision counter-fire. Its operational ranges are consistent with combat helicopters flying close to the ground in complex background environments. Specific tracking systems are described in detail below.

Specifications for the RTATS design are shown in Table 3. The system uses a 512×512 pixel camera with a pixel subtend of 200 prad and associated FOV of 0.1×0.1 radians; the small angular subtend was selected to detect slow targets (mortars) at ranges of several kilometers. The scan format is selectable but the angular search rate is limited by the restrictive field-of-view, step-stare times and the framing rate of the commercial camera. Since the primary focus for crosshairs is on much shorter ranges (≦1 km) the requisite SNR's can be attained with pixel subtends of up to ˜1.0 milli-radian and associated camera FOV's of up to 0.5×0.5 radian. This modification will provide an angular average of 360°×60° (Az×El) in ˜1 second with the current RTATS system. This can be reduced to a fraction of a second with higher torque motors and faster framing cameras.

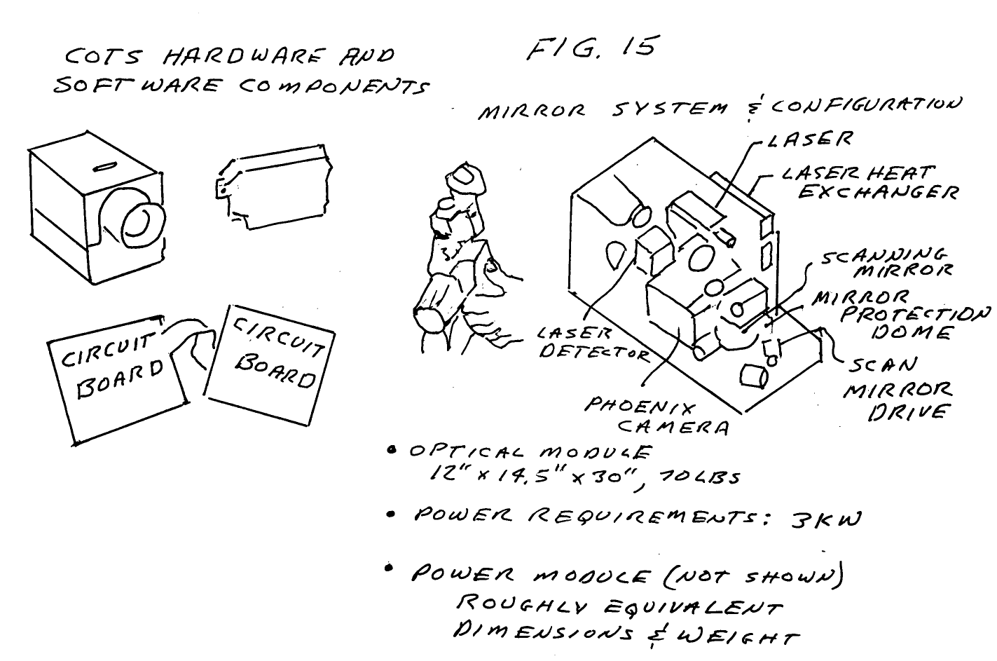

Preferred embodiments of the RTATS system are designed to operate from a moving platform) such as a HMMWV or an airdraft. The optical module is roughly 2.5 cubic feet in size and weighs approximately 70 lbs. The power module is roughly comparable in size and weight. Further weight reduction can be achieved. Applicants project a weight reduction of 25-30%. And significant performance improvements as we gain ground operational experience and account for special needs and tactical advantages for applications to aviation platforms. The RTATS system can be remotely operated and can be readily upgraded for autonomous operation. The baseline RTATS design uses a single-mirror design similar the the systems described in detail below. The optical layout is shown in FIG. 14.

TABLE 3
Design Parameters.

| Sky coverage | 60 × 30 degrees |
|---|---|
| Frame FOV (degrees) | 6 |
| F/# optics | 2.3 |
| Optics aperture diameter (cm) | 5.0 |
| Size pixel array | 512 × 512 |
| Pixel FOV (μrad) | 200 |
| Pixel size (μm) | 25 |
| Camera frame rate (Hz) | 100 |
| Integration time (msec) | 5 |
| Time per frame (msec) | 20 |
| Number moves/FOV scan | 50 |
| Time per scan (seconds)* | 1.00 |

*Time for 60° × 12° coverage 400 msec

### Two Scanning Mirror Concept

An alternative to the single-mirror scanning arrangement described above is a two-mirror scanning system that provides some advantages. A drawing of a two-mirror scanning system is shown in FIGS. 15A, B and C. A scanner of this type is commercially available from suppliers such as GSI Grooup with offices in Billerica, Mass.

### Vehicles

These systems can be installed on a wide variety of vehicles such as aircraft (including un-manned aircrafts (such as unmanned aerial vehicles (UAV's and blimps) and road vehicles such as HMMWV's, tanks and ships.

### Details of a Preferred Tracking System

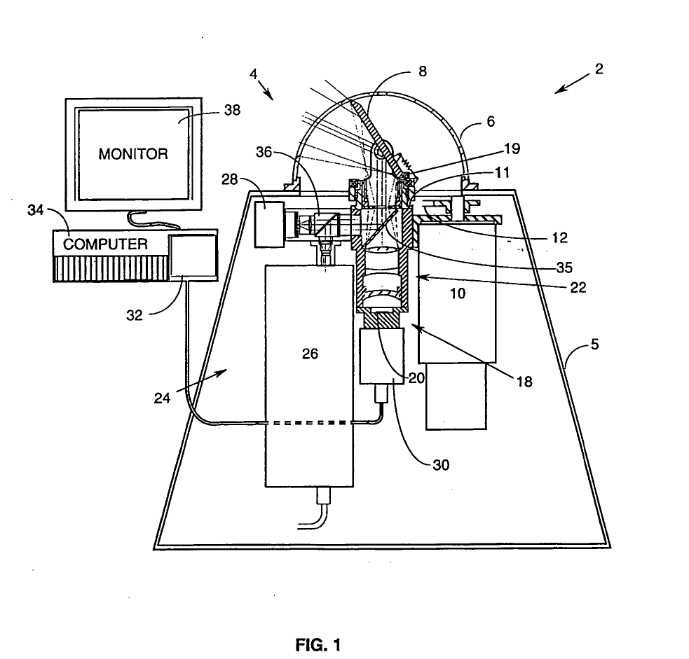

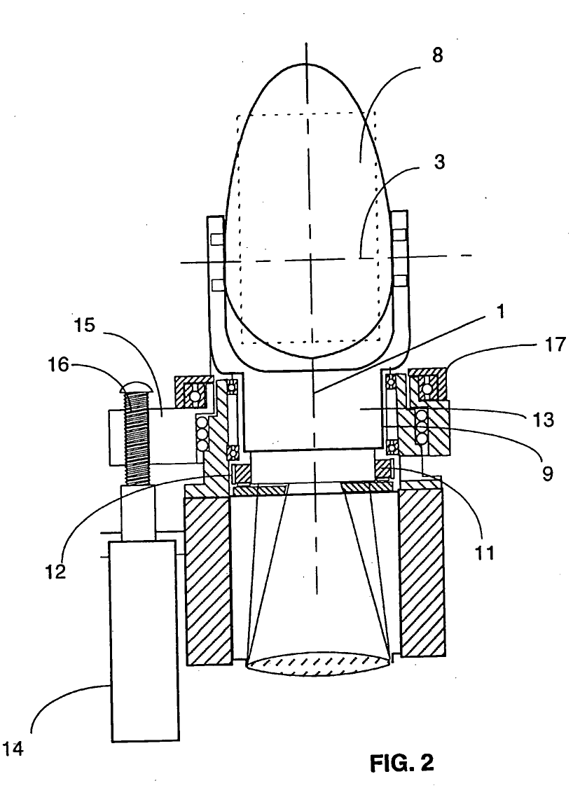

A cross sectional drawing of a preferred embodiment of the present invention is shown in FIG. 1. This embodiment provides a system 2 capable of detecting, tracking and ranging on a sniper bullet in flight. Bullet trajectory information is obtained utilizing an optoelectronic system, coupled to a steerable optical system, for detecting a projectile through the steerable optical system, steering the steerable optical system to track the detected projectile, and generating range and position for the detected projectile. In the preferred embodiment, the optoelectronic system includes a very high speed digital infrared camera and a laser ranging and tracking system. The bullet trajectory information is then used to calculate a back trajectory to identify the firing origin. The origin information is displayed to identify the location of the sniper. The system is contained in case 4 which comprises frame 5 and infrared transparent dome 6. In the illustrated embodiment, step and stare mirror 8 is driven azimuthally by azimuth drive motor 10 and tooth belt 12, while mirror 8 is driven in elevation by elevation drive 14 and worm gear 16 as shown in FIG. 2. Light from a particular field of view is reflected from mirror 8 into telescope 18 which focuses the light from the field of view onto an infrared focal plane array 20. Zoom optics 22 in telescope 20 provide a field of view which is adjustable, preferably between about 4 degrees and 20 degrees. A laser ranging and tracking subsystem 24 includes a laser 26 and a laser range detector 28.

The system has two basic modes of operation. In Mode 1 the system looks for bullets. If an incoming bullet is detected, the system switches to Mode 2 during which it tracks and ranges the bullet.

Mode 1—Scanning for Bullets

In Mode 1, a detection mode, a coverage area which, for example, could be 180 degrees azimuthal and 38 degrees elevation, is continuously scanned. This is accomplished by the step-wise guided movement of step and stare mirror 8. In the illustrated embodiment, the Mode 1 field of view of the mirror-telescope system is about 20 degrees times 20 degrees. Thus, we can cover the 180 degrees times 38 degrees field in 20 step and stare steps, with a 2 degrees overlap in each step.

At the completion of each step, two frames of infrared data are acquired from the focal plane array and are analyzed to detect the presence of a heated bullet. These step and stares occur at an approximate 100 Hz rate, which provides for a full area coverage scan rate of approximately 5 Hz. Therefore, all portions of a 180-degree times 38-degree field of regard are observed each ⅕ second.

### Detection of Incoming Bullet

Bullets tracking through the air typically travel at speeds near the speed of sound and they become hot very quickly, typically in the range of 700-900 degrees K. Telescope 18 images each object field upon mid wave infrared two dimensional focal plane array 20. Array 20 is a commercially available detector array (Model AE186) manufactured by Amber Engineering with offices in Goleta, Calif. It consists of 512 times 512, 25 mu m pixels which are sensitive to radiation between approximately 3 microns to 5 microns in wavelength. Array 20 has a frame rate of approximately 480 Hz. The analog image data generated by the Array 20 is digitized by pixel array control hardware 30 (Model SVS2000) supplied by Lumitron Corporation with offices in Louisville, Ky. This hardware also performs frame to frame pixel subtraction, in the detection mode (Mode 1), and formats the data for output to TMS320C40 digital signal processor boards 32 manufactured by Ariel Corporation having offices in Highland Park, N.J.

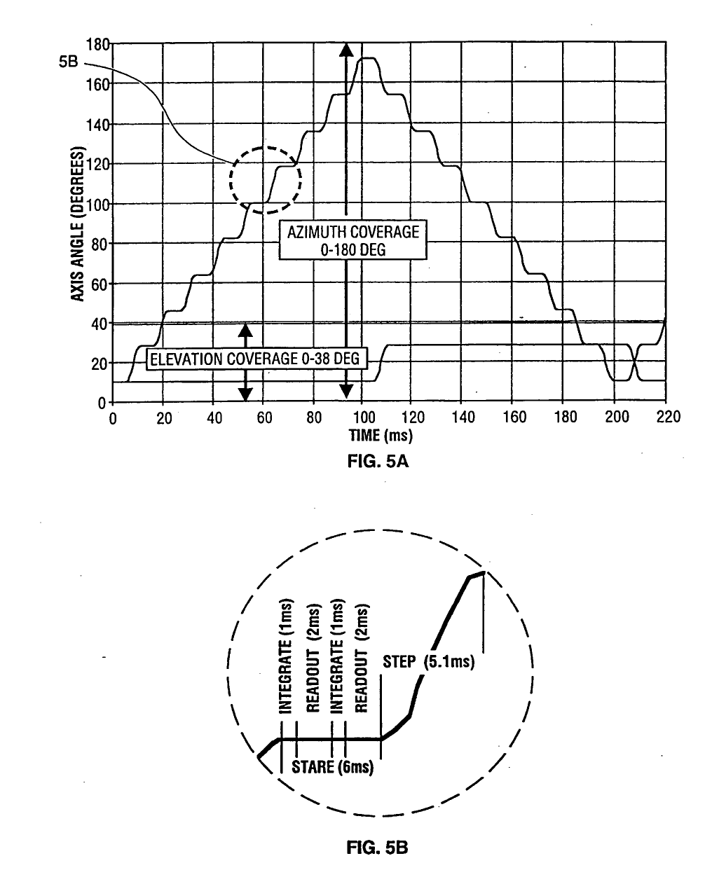

FIG. 5 is a graph showing a typical pointing direction as a function of time and the intervals during which the system is in a “stare” configuration. The frame to frame subtraction makes a hot fast moving bullet relatively easy to detect against the essentially stationary cooler background. The digital signal processor boards 32 calculate the centroid of intensity of the target, if it exists. This centroid data is then passed to a supervisor computer 34 (such as a VXIC850 supplied by National Instruments of Austin, Tex.) which uses this information in Mode 1 to determine if a target has been detected in each step/stare field of view. At night, when background light is small, it may be feasible to eliminate frame to frame subtraction which could speed up the scan rate.

In the detection mode, the mirror can be rotated continuously in one direction or it can be scanned back and forth over a relatively small field or regard (for example, 30 degree). In this application, the term “rotation” is intended to cover back and forth rotation over small arcs such as about 30 degrees.

When the supervisor computer 34 determines that an incoming bullet has been detected, the system is immediately switched from Mode 1 (detection) to Mode 2 (tracking and ranging).

### Mode 2—Tracking and Ranging Bullet

In Mode 2, the variable field of view of telescope 18 is zoomed to about 4 degrees. with zoom optics 22. A digital feedback loop calculated from the bullet image centroid in processor 32 controls the operation of mirror drive motors 10 and 14 in order to place and maintain the bullet image in the center of the telescope 4 degree field of view. When the image is in the center, the laser radar subsystem 24 will begin ranging on the bullet. The laser used in the illustrated embodiment is manufactured by Fibertek Corporation with offices in Herndon, Va. This laser is a pulsed YAG, with a 10 ns pulse width, and up to 250 Hz pulse repetition frequency (PRF). Preferred pulse rates are within the range of 100 Hz to 250 Hz, and preferred pulse widths are between 5 and 20 ns. The YAG output wavelength is 1.06 nm which is shifted to 1.55 nm (an eye-safe wavelength) by passing the beam through an optical parametric oscillator (OPO), also manufactured by Fibertek Corporation. A portion of the outgoing pulse is detected by detector 28 (also supplied by Fibertek Corporation) but substantially all of the pulse is reflected off mirrors 36, 35 and 8 and directed by mirror 8 toward the tracked bullet. A small portion of the laser energy is then reflected from the bullet back to the telescope and is detected by detector 28.

A typical bullet is within the field of regard of the system for about one half second. During tracking, the system collects a set of the following data, typically each 2-10 milliseconds: clock time, laser pulse out time, laser pulse in time, mirror azimuth, mirror elevation, target pixel X position, target pixel Y position. (Mirror elevation and azimuth determine the bullet direction only when the bullet image is at the center of the array 20. The target's X and Y pixel position permits a correction for any deviation of the image from the center pixel.) This provides up to about 500 (but typically 250) sets of bullet positional data per second for each tracked bullet. During the tracking mode, supervisor computer 34 calculates the trajectory of the bullet from the position data and calculates from the data coordinates origins of the bullet. These results may be displayed on monitor 38 in almost real time (i.e., within about one second). The longer the bullet is tracked, the higher the accuracy of the origin prediction.

### Ultra Low Inertia Step and Stare Mirror System

A key element of this invention is an ultra low inertia step and stare mirror system. In the preferred embodiment, the mirror is essentially egg shaped or ellipsoidal, approximately 7 cm times 14 cm, preferably made of beryllium, and weighs several grams. In the illustrated embodiment, a mirror was used that is manufactured by Optical Corporation of America. This mirror is a compromise between small size, and therefore low inertia, and light gathering capabilities. This size will collect enough photons and provide high enough resolution to detect and track a typical bullet at approximately 1 km. Mirror angular position is controlled on both elevation and azimuth to better than 10 .mu.Rad accuracy. Angular accelerations of this driven mirror are as high as 40,000 Rad/s². These accelerations are achievable through the extreme low moving inertia of the mirror, and through the use of three phase, brushless, high torque to inertia ratio motors. In the preferred embodiment, the azimuth motor 10 is a 0.1 HP Electrocraft Brushless Servo motor Model No. E-3629, supplied by Reliance Motion Control with offices in Eden Prairie, Minn. and the elevation motor is a 0.017 HP brushless DC servomotor with a 3:1 gearbox supplied by MicroMo Corporation with offices in St. Petersburg, Fla. In the preferred embodiment, the motor is coupled to a 0.25 diameter drive screw with 10 threads per inch. The pointing accuracy is achieved through the use of a high gain feedback control system using high resolution, high bandwidth, optical angular encoders, such as Model M1 manufactured by Canon Inc. with offices in New York, N.Y.

Mirror 8 may be rotated azimuthally 360 degree by azimuthal drive motor 10 acting through toothed belt drive 12 on pulley 11 which is firmly attached to frame 9, which in turn is firmly attached to mirror axle support 13, as shown in FIG. 2. In the illustrated embodiment, mirror 8 may be pivoted approximately ±10 degrees by vertical drive motor 14 acting through lead screw 16, which raises and lowers lift ring 17, which in turn raises and lowers the lower edge of mirror 8 acting through roller 19 which travels in a radial track in lift ring 17. This causes mirror 8 to pivot up to approximately ±10 degrees about the horizontal axis of mirror 8. Thus, part 16 rotates about its axis. Part 15 moves vertically; parts 11 and 13 move azimuthally only, part 17 moves azimuthally and vertically and part 19 moves azimuthally, vertically and radially. Thus, the step and stare mirror 8 moves azimuthally about axis 1 and pivots approximately ±10 degrees about axis 3.

This seemingly complicated arrangement permits two axis operation of mirror 8 without one of the drives having to deal with the inertia of the other drive unit. Both motor drives are mounted on the stationary portion of system and are independent of the moving axes. Thus, the total weight which has to be rotated azimuthally is reduced to about 0.6 pounds and the total weight which has to be moved vertically is about 0.4 pounds for this preferred embodiment. These weights are based on use of a beryllium mirror. Aluminum and glass mirrors are inexpensive but significantly heavier.

### Details of a Second Preferred Tracking System

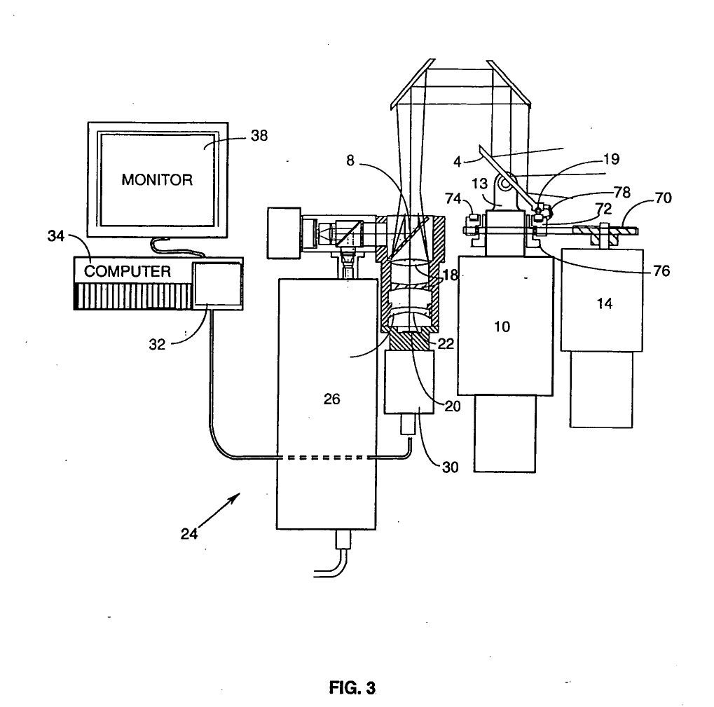

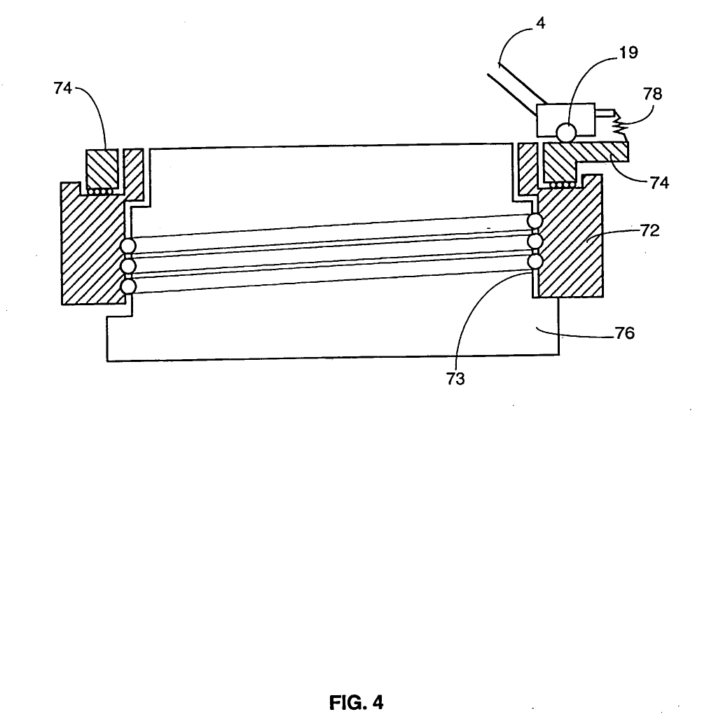

A sketch of a second preferred embodiment of the present invention is shown in FIG. 3. In this case mirror support 13 is firmly attached to the drive shaft of azimuth motor 10. Vertical pivoting is provided by elevation drive motor 14 acting through pulley 70 on lift ring 72 which supports rotating track ring 74. A threaded roller bearing 73 acting between lift ring 72 and stationary support ring 76 causes lift ring 72 to rise and lower when the shaft of elevation drive 14 is rotated by drive belt 70. Roller bearings along the bottom of rotating track ring 74 permit rotating track ring 74 to rotate with mirror support 13. Thus, support 13 rotates in azimuth; stationary support ring 76 is stationary; left ring 72 rotates in azimuth as driven by elevation driver 14 and moves in elevation; and rotating track ring 74 moves in elevation with lift ring 72 but rotates in azimuth as driven by azimuth drive motor 10 as it is dragged around by roller 19 which runs in a radial track in rotating track ring 74. Spring 78 holds roller 19 in the radial track on rotating track ring 74. A blowup showing these features is shown in FIG. 4.

Under normal circumstances, origin of the projectile can be determined by following the ballistic back projection until it intersects a stationary object, e.g., the window of a building. However, the origin may not always be from a stationary object, but may originate from an ambiguous set of locations, e.g., one of several trees or hills along the ballistic path. Correlation between device measured ballistic trajectory and known ballistic coefficients can be used to eliminate or reduce these ambiguities. Ballistic coefficients/conditions for the majority of standard rifle/cartridge combinations have been characterized for some time by cartridge manufacturers, and by the military. Initial (muzzle) conditions are part of the known cartridge/rifle characterizations. Using the correlation between the bullet under track and the known coefficients, type of cartridge/rifle used can be identified. Then, using the known initial conditions for the identified cartridge/rifle and the ballistic back projection calculated for the bullet under track, the origin of the bullet can be calculated to a high degree of accuracy.

In the described preferred embodiments, during Mode 1 (step and stare detection) two frames of data are acquired and differenced during each stare. This function is to maximize signal to clutter ratio, and to be used as a moving target indicator (MTI). In scenarios where the background clutter temperatures are low, only one frame per stare is necessary. This effectively decreases the time between steps, and improves the area coverage rates.

The laser radar described uses a pulsed solid state laser, and a direct detection method from which radial range data is derived. Alternatively, a heterodyne detection system could be incorporated which will allow derivation of both radial range and radial velocity data. Also a pulsed gas laser, e.g., CO₂ may be used.

The coverage area described above as 180 degrees by 38 degrees or 360 degrees times 20 degrees is arbitrary, and can be expanded to 360 degree by >90 degrees, at the cost of step/stare coverage rate. Information of calculated projectile origin can be presented to user through a computer display with angle/angle range from device, and/or with a point or “x” on computer generated situation map, and/or with GPS world coordinates. Alternatively, a beam of light from a spotlight or laser (e.g., HeNe) can be slewed by the device to point out the origin of projectile. Also, the device could transmit GPS correlated origin data via RF or light communications to personnel, who can identify the origin location using GPS equipment. Alternatively, the personnel can use a GPS equipped pointing system which will receive the GPS correlated data from device, and point the user to the origin position using electronic crosshairs and/or other direction indicators. It should be appreciated that information of the calculated origin of a projectile may be presented by other means known in the art, and such alternatives are contemplated herein.

In the case where device is used to detect and track incoming weapons, e.g., a mortar or artillery round, the device can be used to control an autonomous response, e.g., launch and steer an intercept vehicle, or steer and fire a high power laser beam, in order to destroy the weapon prior to impact with its target.

Detector arrays sensitive at wavelengths other than 3 to 5 microns may be used, e.g., 8 to 11 microns infrared, and/or visible. In addition, multiple arrays, with different sensitive wavelengths may be imaged coaxially through the optical system, and the data from said arrays can be fused to improve data validity.

### Details of a Third Preferred Tracking System

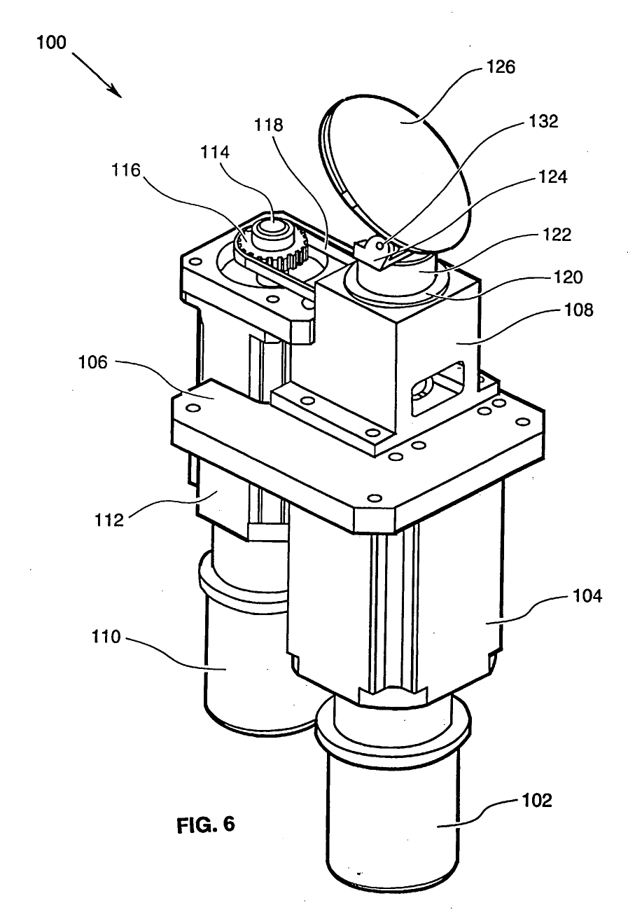

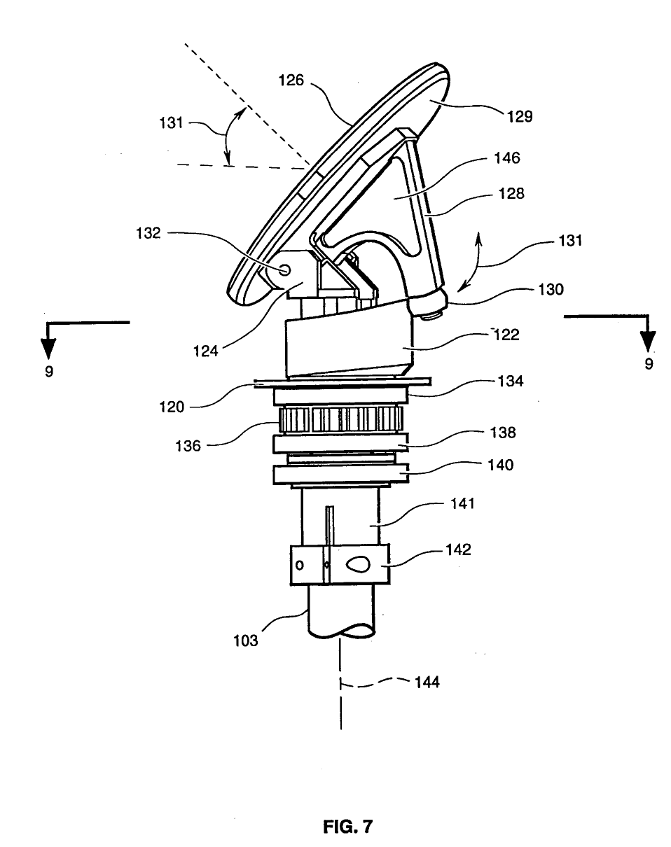

Referring now to FIG. 6, yet another alternative embodiment of the Projectile Tracking System of the present invention is shown and generally designated 100. Projectile Tracking System 100 includes an azimuth drive motor 102 having a rotational element 103 (such as a motor shaft, shown in FIG. 7) that extends through housing 104 and base plate 106, and into bracket 108. Elevation drive motor 110 has a rotational element 114 (such as a motor shaft) which passes through housing 112 and base plate 106, and is equipped with an elevation drive gear 116. As will be discussed in greater detail below, rotation of elevation drive gear 116 causes belt 118 to rotate elevation cam gear 136 (shown in FIG. 7), which in turn rotates elevation cam 122 above cam plate 120. Rotation of elevation cam gear 136 and the corresponding rotation of elevation cam 122 causes step and stare mirror 126 (“stare mirror”, for short) to pivot about bracket pin 132 of mirror bracket 124, thereby changing the elevation angle 131 of the mirror 126.

FIG. 7 shows the azimuth drive rotational element 103 extending into a coupler 142 which transfers the rotation of the rotational element 103 along axis 144 to shaft 141. Mirror bracket 124 is attached to the end of shaft 141 such that rotation of the rotational element 103 causes mirror bracket 124 and stare mirror 126 to rotate. In order to ensure the stability of shaft 141 during often very high speed rotation, a bearing 140 is positioned along shaft 141. Additional bearings may be incorporated along the length of shaft 141 to further minimize rotational instability.

Elevation cam gear 136 is positioned coaxially around shaft 141, and may rotate independently of the shaft 141. Upper bearing 134 and lower bearing 138 provide for the rotational stability of elevation cam gear 136 as it rotates about shaft 141. Elevation cam 122 is attached to elevation cam gear 136 such that rotation of the elevation cam gear 136 results in corresponding rotation of the elevation cam 122.

Positioned within the mirror bracket 124, and secured in place with bracket pin 132, is stare mirror 126. As can be appreciated from FIG. 7, cam follower bracket 128 extends from the back side 129 of stare mirror 126, and is equipped with a cam follower 130. Cam follower 130 is designed to roll along the outer surface of elevation cam 122 and pivot cam follower bracket 128 and stare mirror 126 about bracket pin 132 in directions 131. Because the elevation cam may be rotated independently of azimuth shaft 141, the elevation of stare mirror 126 may be changed by rotating the elevation cam with respect to the azimuth shaft 141.

Due to the high rotational velocities of stare mirror 126, and the potential to nearly instantaneously reverse the direction of rotation, cam follower bracket 128 is preferably formed as an open frame; that is, with a hollow portion 146. The formation of hollow portion 146 greatly decreases the inertia of the rotation stare mirror 126 and cam follower bracket 128, thereby further improving the angular acceleration and deceleration rates of the rotating state mirror.

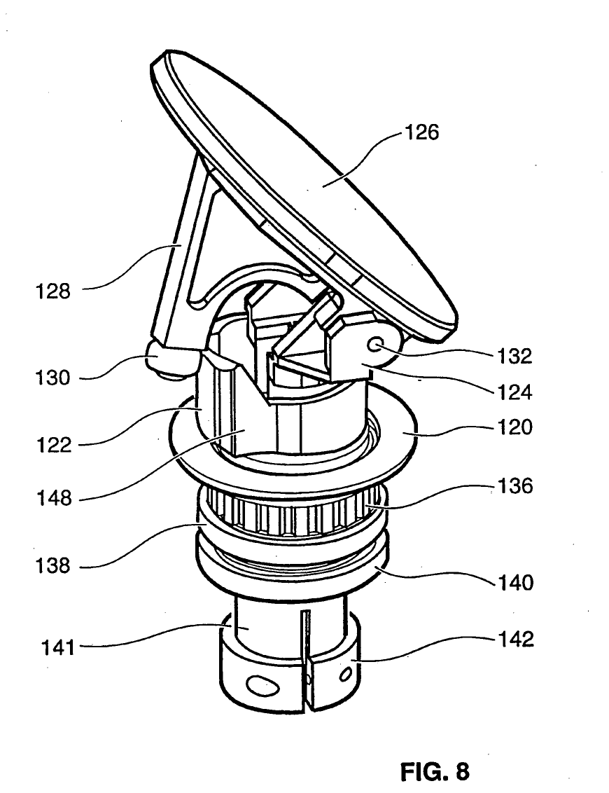

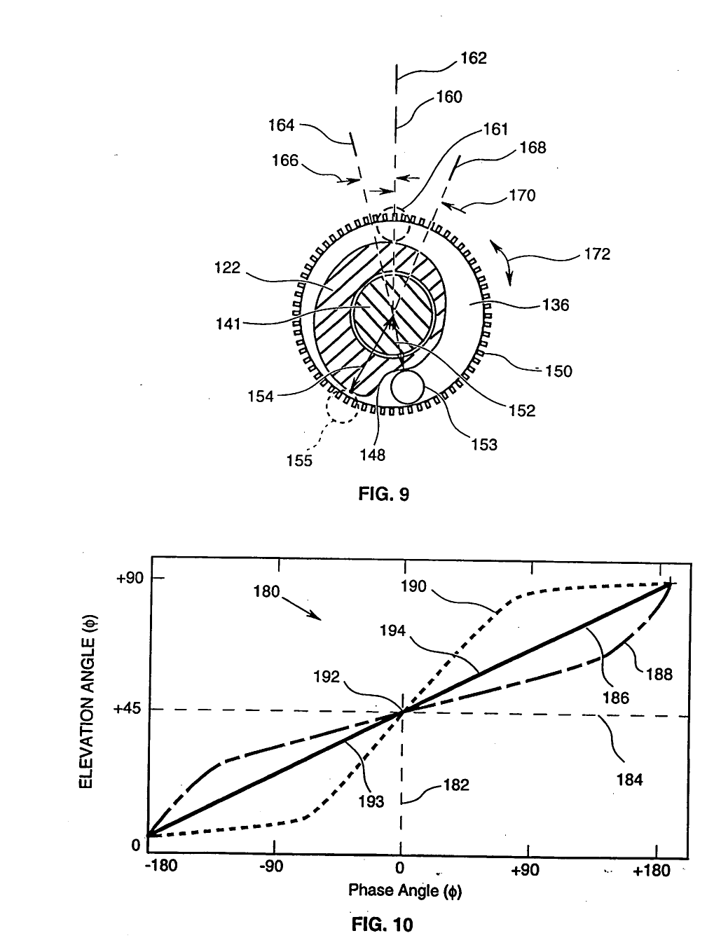

Referring now to FIG. 8, an alternative perspective view of the Projectile Tracking System of the present invention is provided and shows the helical nature of elevation cam 122. More specifically, with reference to FIG. 9, elevation cam 122 is shaped to have a first radius 152 and a second radius 154, with a helical portion between the first and second radii. In a preferred embodiment, the first radius 152 is such that the elevation angle 131 is at a minimum, such as 0 degree above horizontal. Also, the second radius 154 may be such that the elevation angle 131 is at a maximum, such as 90 degrees above horizontal.

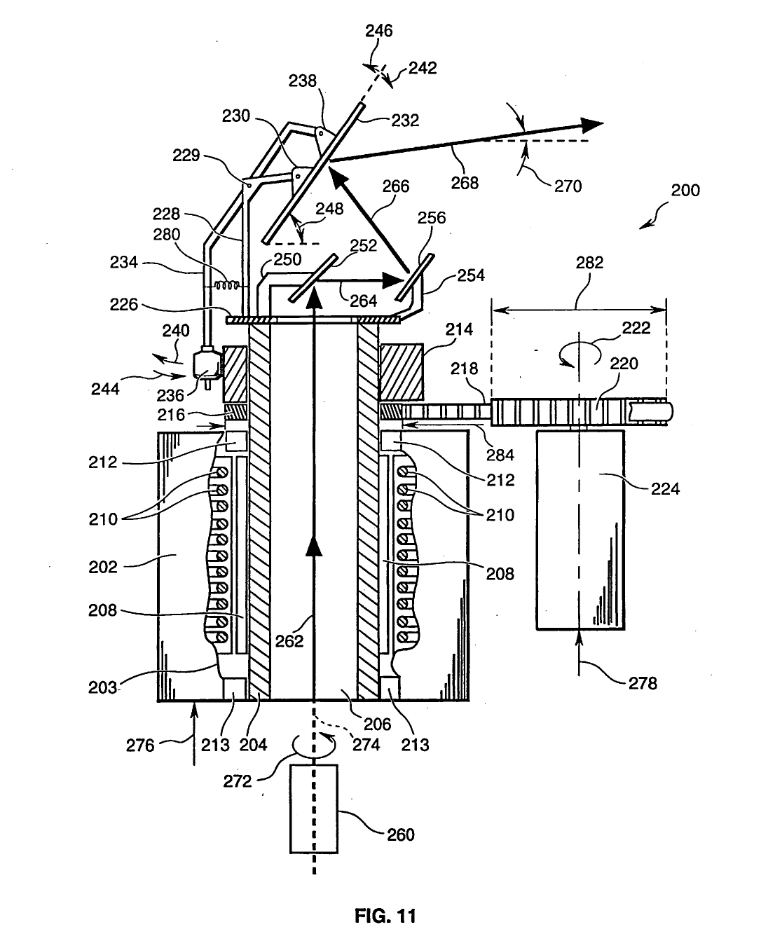

Due to the angular change in radius of elevation cam 122, a transition slope 148 may be included to allow the cam to be rotated in both directions 172. The incorporation of the transition slope 148 is important as it enables bidirectional rotation, while at the same time ensuring that the cam follower 130 and stare mirror 126 will not be instantaneously stopped when attempting to rotate elevation cam 122 directly from low elevation position 153 to high elevation position 155. The operation of the Projectile Tracking System may be fully appreciated by referring to FIGS. 9 and 10. As discussed above, in the illustrated embodiment, elevation cam 122 is driven by elevation drive motor 110 via belt 118, and belt 118 engages teeth 150 on elevation cam gear 136 such that the elevation cam gear 136 may be rotated about azimuth shaft 141. (Although a belt 118 has been discussed herein, it should be appreciated that elevation motor 110 may be directly coupled to or an integral part of elevation cam 122, thereby eliminating the need for the belt 118). With the azimuth shaft 141 in an initial rotation position 162, cam gear may be positioned at an initial rotational position 160 resulting in cam follower 130 being in position 161. In a preferred embodiment, position 161 may correspond to an elevation angle 131 of about 45 degree.

FIG. 10 shows a graphical representation of the relationship between the elevation angle 131 of the stare mirror 126, and the rotational phase difference between the azimuth angle drive motor 102 and the elevation angle drive motor 110. More specifically, graph 180 includes an X-coordinate axis for the elevation angle 131, and a Y-coordinate axis for the phase difference between the azimuth angle drive motor 102 and the elevation angle drive motor 110. In these initial rotational positions 160 and 162, the 45 degree elevation angle 131 of stare mirror 126 may be shown as point 192 on graph 180.

As elevation cam gear 136 is rotated from rotational position 160 to rotational position 164, the cam radius will increase, resulting in a decrease in elevation angle 131. Conversely, as elevation cam gear is rotated from rotational position 160 to rotational position 168, the cam radius will decrease, resulting in an increase of the elevation angle 131. Graphically, the change in rotational phase between position 160 and 164 would correspond to movement along curve 186 from point 192 to 193, and the change in rotational phase between position 160 and 168 would correspond to movement along curve 186 from point 192 to 194.

While it has been discussed that the phase change between the azimuth shaft 141 and the elevation cam 122 determines the elevation angle of the stare mirror 126, it should be appreciated that the azimuth drive rotates simultaneously, or independently of, the elevation cam 122. If both the azimuth drive 141 and the elevation cam 122 rotate in the same direction at the same rate, than the phase difference is unchanging, resulting in the side sweeping of the stare mirror at a constant elevation angle 131. On the other hand, if the elevation cam is rotated in the same direction, but at a slower rate, than the azimuth drive, the phase difference and corresponding elevation angle will change. In this manner, by rotating the azimuth drive and elevation cam independently, it is possible to point the stare mirror to any location in three-dimensional space nearly instantaneously.

Although elevation cam 122 is shown having a curvature which changes linearly from a small radius 152 to a large radius 154 as depicted by curve 186 on graph 180, it is possible to incorporate elevation cams having different shapes. For instance, curve 188 on graph 180 depicts an elevation cam having a linear portion with a lesser slope than curve 186 through most of the region between the −90 degree and +90 degree phase angles. This lesser sloped region would provide an elevation angle accuracy of more than the linearly changing elevation cam. This is particularly advantageous in situations where a greater level of elevation angle positional accuracy is required between approximately 30 degrees-60 degrees.

In situations where it is desirable to have a greater level of elevation angle positional accuracy, an elevation cam 122 having characteristics shown by curve 190 may be appropriate. More specifically, the elevation cam depicted by curve 190 would be formed with a rapid elevation angle transition between approximately 10 degrees-80 degrees, resulting in a greater level of elevation angle positional accuracy between 0 degree-10 degrees and 80 degrees-90 degrees.

Although the preferred embodiment discussed in conjunction with FIGS. 6-10 exhibits a change of elevation angle from 0 degrees-90 degrees, it should be appreciated that the elevation angle of the stare mirror may exceed this range. More particularly, the shape and radius of the elevation cam may be modified to provide for an elevation angle ranging from about −20 degrees. to about 100 degrees. This elevation range, combined with the rotation of the azimuth drive, will provide for a stare mirror range greater than hemispherical coverage.

While not critical, it is advantageous that the diameter of the elevation drive gear 116 and the elevation cam gear 122 be essentially exactly the same. This is so because the rotational accuracy of the motors is sufficient to position their respective rotational elements to within 1/200,000 of a revolution, or approximately 32 micro radians. With this level of rotational accuracy, it is possible to position the elevation of the stare mirror to within about 0.00045 degrees of a desired elevation angle 131.

High acceleration rates with relatively large apertures and large coverage areas were not available in other devices. The coaxial elevation cam 122 eliminates the need for a motor to be physically mounted along the elevation axis, and further lowers the inertia for elevation angle changes. More specifically, the present invention allows for near hemispheric coverage angles, with large apertures, at extremely high acceleration rates. By mounting both motors fixed relative to the azimuth axis, and by actuating the elevation axis via a cam co-axially mounted around the azimuth rotational element, the azimuth motor only has to deal with the azimuthal inertia of the mirror and mounting assembly. The elevation motor must deal only with the rotational inertia of the cam and the elevation inertia of the mirror and mount.

In order for the Projectile Tracking System of the present invention to properly track its target, it is desirable to minimize the wear and tear on the mechanical linkage components of the system which, over time, would create or compound positional inaccuracies. The elevation cam 122 and cam follower 130 of the present invention minimizes any build-up of inaccuracies by determining the elevation angle using only the rotation of the elevation cam. While there may be some wear of the cam follower 130, such wear will be minimal, and may be further minimized by using a bearing (not shown) within the cam follower, and by pre-charging this bearing to avoid physical changes in the bearing.

### Details of a Fourth Preferred Tracking system

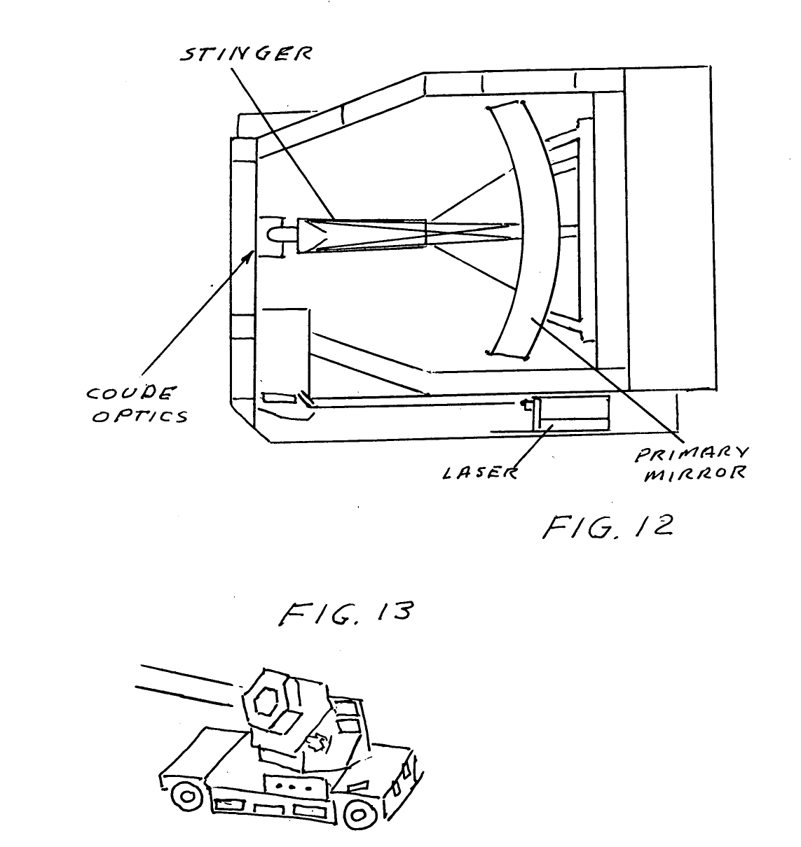

FIG. 11 shows an alternative embodiment of the Projectile Tracking System of the present invention, generally designated 200. Projectile Tracking System 200 includes an azimuth drive motor 202, shown with portions 203 removed for clarity. The azimuth rotational element 204 of motor 202 is formed with a bore 206, and is equipped with permanent magnets 208 positioned for reacting with electrical windings 210 to rotate the rotational element. Shaft 204 is supported within motor 202 by upper shaft bearings 212 and lower shaft bearings 213.

Elevation cam 214 is positioned around azimuth drive rotational element 204 and is attached to elevation cam gear 216. Like the preferred embodiments discussed above, the elevation cam gear 216 and elevation cam 214 may be rotated independently of rotational element 204. Drive belt 218 extends between elevation cam gear 216 and elevation drive gear 220, such that rotation of elevation drive gear 220 is rotated in direction 222 by elevation drive motor 224, elevation cam 214 is also rotated.

Mounted to the upper end of azimuth rotational element 204 is base plate 226 from which extends a stare mirror support 228, having a pivot 229, and attaching to pivot bracket 230 of stare mirror 232. Cam follower lever 234 pivots through pivot 229 and connects to stare mirror 232 via cam follower linkage 238. Cam follower 236 is attached to the end of the cam follower lever 234, and rolls along the outside of elevation cam 214 as it is rotated. More specifically, when elevation cam 214 is rotated and pushes cam follower 236 in direction 240, cam follower lever 234 pivots about pivot 229 to cause stare mirror 232 to pivot in direction 242 changing elevation angle 248. Similarly, when elevation cam 214 is rotated and pushes cam follower 236 in direction 244, cam follower lever 234 pivots about pivot 229 to cause stare mirror 232 to pivot in direction 246.

Extending from base plate 226 is an arm 250 supporting first deflecting mirror 252 over bore 206. Also, arm 254 extends from base plate 226 to support a second deflecting mirror 256. A particular advantage of this preferred embodiment is that Projectile Tracking System 200 may rotate through a full azimuth rotation without moving its laser source or sensor. More specifically, a laser 260 may be positioned within, or just outside, bore 206 and directed along optical beam path 262. First deflecting mirror 252 re-directs beam 262 to beam 264 which is in turn re-directed to beam 266 by second deflecting mirror 256. Beam 266 strikes stare mirror 232 to be re-directed to beam 268 at an elevation angle 270, which is determined by elevation cam 214. In this manner, beam 268 may be directed anywhere in at least a hemispherical range, by modification of elevation angle 270 and rotation of azimuth rotational element 204 in direction 272.

Laser source 260 may be positioned away from motor 202, so long as the laser beam is re-directed to optical axis 274. Also, electrical control of azimuth drive motor 202 and elevation drive motor 224 are controlled via electrical inputs 276 and 278, respectively. Such motor control would be generated, for example, by the supervisor computer 34 shown in FIG. 1.

In order to facilitate the rapid azimuthal rotation of stare mirror 232, it is advantageous to provide a spring 280 which urges cam follower 236 against the elevation cam 214. Such urging would resist the centrifugal tendency of cam follower 236 to move in direction 240 as the azimuth rotational element 204 rotates in direction 272.

The diameter 282 of elevation drive gear 220 may be the same as the diameter 284 of elevation cam gear 216. In such a situation, the rotation of the elevation cam gear 216 will correspond to the elevation drive motor 224. This provides for a high degree of rotational accuracy, as well as the ability to track the elevation angle 248 of the stare mirror 232. It should be appreciated, however, that the diameters 282 and 284 may differ. In circumstances where a degree of accuracy greater than 1/200,000 is needed, it would be possible to incorporate an elevation cam gear 216 having a greater diameter 284. On the other hand, where a high degree of accuracy is not needed, it would be possible to incorporate an elevation cam gear 216 having a smaller diameter.

While Projectile Tracking System 200 has been discussed in conjunction with a laser source 260, it is to be appreciated that a sensor may be used instead. For instance, an infrared or other light sensor may be used, with the stare mirror collecting these light signals and redirecting them to deflection mirrors 256 and 252 for viewing along the optical axis 274. Also, a series of lenses may be incorporated into the Projectile Tracking System 200 to further refine the light signals re-directed by stare mirror 232.

### Multiple Targets

Applicants and their fellow workers pioneered the development of multiple target telescope system (called ROBS) and has fielded two complete 50 cm aperture systems for test range applications. The first generation ROBS system is routinely used to monitor ballistic missile intercepts at stand-off ranges of up to ˜300 km. The second generation system (called “3DATA”) system was recently completed. It will be used initially for range radar dynamic calibrations and monitoring sensor fused weapons tests. Eventually it will be mounted on a 300 ft tower for monitoring high rate air-to-ground munitions release and scoring their impact errors in target attack tests with live munitions (over the Gulf of Mexico) at ranges of up to at least 50 km.

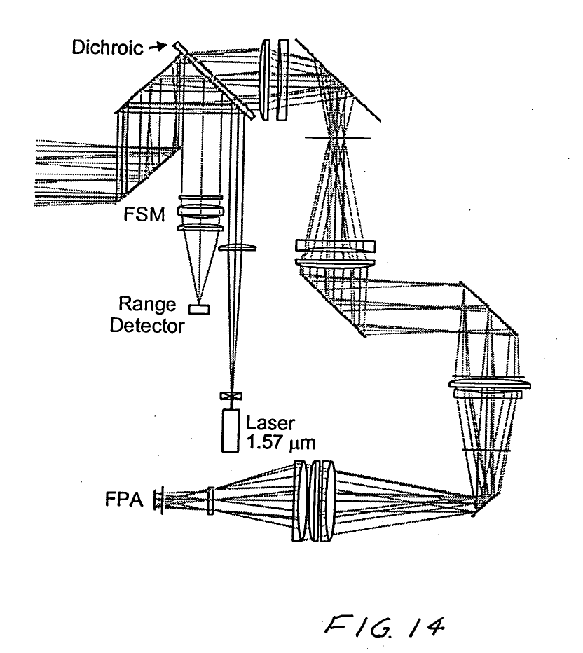

The ROBS/3 DATA hardware, operating concept and multi-target tracking capabilities are illustrated in FIGS. 12-18. The 3DATA optical system is based on a 0.8-meter f/1.2 spherical primary (Corning ULE, 90% light weighted), with 0.5-meter active aperture which has <¼ wave rms imaging performance at 1 μm (see FIG. 1 below) The unique feature of the 3DATA telescope is the roving fovea design, which points the 3.5 milli-radian×3.5-milli-radian field-of-view, over the 17.5-deg×17.5-deg field-of-regard, by moving a lightweight secondary mirror system (stinger). The lightweight stinger results in an extraordinarily fast pointing and tracking system, capable of moving in random 3-deg increments at 50 Hz over the full field-of-regard. The current system has a retargeting rate of up to 20 Hz and has a capability to track 20 simultaneous targets. The all reflective optical path is shown in FIG. 12. FIG. 13 shows the system mounted on a trailer.

Applicants are currently working to place a ROBS unit on a US Navy barge to provide highly accurate track files of two simultaneous missile targets from it in heavy seas. Applicants and their fellow workers have completed a design to integrate and operate ROBS on a Boeing jet aircraft that would not require a mechanical vibration isolator for the mount. Through this design effort, Applicants learned that the ROBS high angular agility was sufficient to remove the aircraft in-flight vibration frequency induced base motion and support highly accurate long-range missile tracking.

Tracking systems described above have demonstrated a capability of rapidly detecting and acquiring it in flight and accurately tracking it in 3 dimensions (angle-angle-range) with a location accuracy of ˜1 m³. Angular rates of 1000 rad/sec and acceleration rates of 40,000 rad/sec² were required and have been demonstrated. Once in track, the position of the intended hit point and the fire position can be determined to within a few meters accuracy (see Table 1). The drag inefficient can be readily determined to establish the caliber of the bullet and this can in turn be used to track back to the ‘muzzle’ location. The detection relied only on gas dynamic heating of the bullet. All bullets fired at were detected from surveillance, tracked and shooter found. Since 100% of the snipers were found from single shots during two different tests

TABLE 1
Surveillance and Tracking Mode System Parameters

| | |
|---|---|
| Entrance Aperture | 2 cm (surveillance), 6 cm (tracking) |
| Total FOV | 20-deg × 20-deg (surveillance), 6.5-deg × 6.5-deg |
| (tracking) | |
| Bandpass | 3.4-4.2 μm |
| Dwell Time | 1 msec |
| Readout time | 2 msec |
| Camera D* | 1.053 × 10¹² cm\sqrt{Hz}/W |
| Frame rate | 325 Hz (max 480 Hz) |
| Dynamic range | 12 bits |
| Pixel IFOV | 680 μrad (surveillance), 220 μrad (tracking) |
| .50 cal at 1 km | ˜10 μrad subtended angle |
| Pixel physical size | 25 μm |
| Bullet temp | 630 deg-K |
| Background temp | 300 deg-K, 2 deg-K 1-σ variance |
| Surveillance volume | 180-deg azimuth × 38-deg elevation |
| Volume revisit rate | ˜5 Hz |

### Threat Warning System

A conceptual threat warning sensor (TWS) can be included to detect the elevation and azimuth angles of (muzzle or launch) flashes from small arms fire and missile/rocket launches within its view. Its design provides a scan-free continuous coverage of all airspace under and slightly above a combat helicopter flying nape of the earth. It can be used to point a TV camera feeding an operator display and a gun at the gunfire flash angles as an automated threat detection response. Points within the TV imagery can be automatically highlighted to provide a human operator the visual imagery needed to manually verify his defensive guns are on target to prevent collateral damage incidents. The TWS would cue the IR camera of the tracking sensor to initiate track of any launched threat munitions to shorten the active track response timeline. The resulting 3-D track would determine if the flash was small arms, a rocket, RPG, flash-bang countermeasure, etc. The following table describes the TWS specifications.

TABLE 2
TWS Performance Specifications

| | |
|---|---|
| Entrance Pupil Diameter | 10 mm (>5 mm) |
| Wavelengths | 3.2-4.7 microns. |
| Full Field Of View | (FFOV) 200 degrees (>180) |
| Angular Resolution | 3 milliradians (<6 mr) |
| Spot Size | <40 microns |

While the above descriptions contain many specificities, the reader should not construe these as limitations on the scope of this invention, but merely as exemplifications of preferred embodiments thereof. These systems can be used to track and guide missiles fired by the vehicle it is located on to destroy an enemy or terrorist target. It might be feasible to make a light weight version of the present invention that can be carried by soldiers, national guard personnel or police to locate snipers or to guide missiles toward them. Those skilled in the art will envision many other possible variations which are within its scope. Accordingly, the reader is requested to determine the scope of the invention by the appended claims and their legal equivalents and not by the examples which have been given.

What is claimed is:

1. A missile protection system for a moving vehicle, comprising:
A) a steerable optical system mounted on said vehicle;
B) an optoelectronic system, coupled to the steerable optical system, for detecting a projectile through the steerable optical system, steering the steerable optical system to track the detected projectile, and generating range and position for the detected projectile;
C) an analysis system, coupled to the steerable optical system and the optoelectronic system, for determining the trajectory of the detected projectile based upon range and position data generated by the optoelectronic system.

2. The system as in claim 1 and further comprising a kill system for destroying the sores of said projectile.

3. The system as in claim 1 wherein said steerable optical system is a single-mirror system.

4. The system as in claim 1 wherein said steerable optical system is a two-mirror system.

5. A missile protection system for a moving vehicle, comprising:
A) a steerable optical system mounted on said vehicle including:
1) an azimuth drive motor having a rotational element defining an axis of rotation;
2) a step and stare mirror mounted to the rotational element of the azimuth drive motor along the axis of rotation, and pivotable to define an elevation angle;
3) an elevation cam mounted coaxially about the axis of rotation;
4) an elevation drive motor coupled to the elevation cam to rotate the elevation cam about the axis of rotation;
5) a cam follower extending from the step and stare mirror and in contact with the elevation cam wherein rotation of the elevation cam results in a corresponding change in elevation angle;
B) an optoelectronic system, coupled to the steerable optical system, for detecting a projectile through the steerable optical system, steering the steerable optical system to track the detected projectile, and generating range and position for the detected projectile; and
C) an analysis system, coupled to the steerable optical system and the optoelectronic system, for determining the trajectory of the detected projectile based upon range and position data generated by the optoelectronic system.

6. The system of claim 5, wherein the rotational element of the azimuth drive motor is formed with a longitudinal bore for passing light through the rotational element to the step and stare mirror.

7. The system of claim 6, further comprising a first and second deflecting mirror, wherein the light passed through the rotational element is redirected by the first deflecting mirror and the second deflecting mirror to the step and stare mirror.

8. The system as in claim 5 and further comprising a kill system for destroying the sores of said projectile.
